(19) United States
(12) Patent Application Publication
(10) Pub. No.: US 2013/0287250 A1
(43) Pub. Date: Oct. 31, 2013

(54) METHOD AND APPARATUS FOR TRACKING OBJECT IN IMAGE DATA, AND STORAGE MEDIUM STORING THE SAME

(71) Applicant: ELECTRONICS AND TELECOMMUNICATIONS R, Daejeon (KR)

(72) Inventor: Jae Yeong LEE, Daejeon (KR)

(73) Assignee: ELECTRONICS AND TELECOMMUNICATIONS RESEARCH INSTITUTE, Daejeon (KR)

(21) Appl. No.: 13/660,987

(22) Filed: Oct. 25, 2012

(30) Foreign Application Priority Data
Apr. 25, 2012 (KR) 10-2012-0043257

(51) Int. Cl. G06K 9/46; G06K 9/00

(52) U.S. Cl. 382/103; 382/170

(57) ABSTRACT

Disclosed is a system for tracking an object in an image. A method for tracking an object in an image according to an exemplary embodiment of the present invention includes generating an object model represented by multiple patch histograms of an object that is divided into N partial patch regions and histograms are built from each patch region, forming an object model; estimating the probability of each image pixel being an object pixel; and determining the most promising location of an object in the image by using the estimated object probability values. According to the exemplary embodiment of the present invention, it is possible to more improve separability from a background than a case in which a single histogram mode is used, to increase tracking performance, and to more accurately search the object region than a mean-shift method of the related art.

### CROSS-REFERENCE TO RELATED APPLICATIONS

This application claims priority to and the benefit of Korean Patent Application No. 10-2012-0043257 filed in the Korean Intellectual Property Office on Apr. 25, 2012, the entire contents of which are incorporated herein by reference.

### TECHNICAL FIELD

The present invention relates to a method for tracking an object in an image, and particularly, to a technology of tracking a specific object in an image acquired by an image acquisition apparatus such as a camera, and the like.

### BACKGROUND ART

A technology of tracking a mobile body in an image is one of the critical technology elements for high-level vision recognition operations such as security, surveillance and reconnaissance, human-robot interaction (user follow up), human behavior recognition, mobile path analysis, path prediction, and the like.

The most representative method of method for tracking a mobile body in an image is a histogram based mean-shift tracking method. The mean-shift tracking method can be easily implemented and can rapidly and effectively track a moving object and therefore has been widely used as the most basic method in a visual tracking field.

However, according to the mean-shift tracking method of the related art, a single histogram for an image is used, and thus location information on each color value is lost and when the background has the color distribution similar to an object, it is difficult to discriminate an object region from the background and to find out an accurate location.

Therefore, in order to solve the problems of the histogram based mean-shift tracking method, various methods have been researched, but mostly require complicated algorithms and high computations and therefore can hardly be applied to applications requiring real-time.

### SUMMARY OF THE INVENTION

The present invention has been made in an effort to provide a method for tracking an object in an image capable of exhibiting tracking performance with high accuracy while maintaining convenience and real-time tracking performance of a histogram based mean-shift method of the related art, in tracking an object in an image acquired by an image acquisition apparatus.

An exemplary embodiment of the present invention provides a method for tracking an object in an image, including: generating, by an object model generating unit, an object model represented by multiple patch histograms of an object (an object region in an input image is divided into N partial patch regions and histograms are built from each patch region, forming an object model); estimating, by an object probability estimating unit, the probability of each image pixel being an object pixel; and determining, by a location determining unit, the most promising location of an object in the image by using the estimated object probability values.

The object model generated in the step of generating of the object model may include location information of the patch histograms, that is, the location of the corresponding patch region in the object image.

In the generating of the object model, the manner of an object region being divided into partial patch regions or the number of patches-may be determined based on what the tracked object is.

In the generating of the object model, N patch histograms for the N partial image patches may be generated.

In the estimating of the object probability, an object probability value may be estimated by using the generated object model.

In the estimating of the object probability, it is desirable to estimate the probability of an image pixel being populated from an target object.

In the estimating of the object probability, the object probability of image pixels may be estimated by using so called a histogram backprojection technique, which is described in the section of detailed description (refer to Equation 1 and Equation 2), forming a histogram backprojection image where the value of each pixel denotes the object probability. Note that we have N backprojection images if the object model consists of N patch histograms as one backprojection image is obtained for each patch histogram.

In the determining of the location, a location at which the sum of the pixel probabilities of an object candidate region in the generated backprojection image is maximized may be determined as the location of the object.

When computing the sum of the pixel probabilities of a candidate object region, the object probability of each pixel of the candidate region is set to the pixel value of the corresponding backprojection image generated from the corresponding patch histogram of the pixel location among N backprojection images.

Another exemplary embodiment of the present invention provides an apparatus for tracking an object in an image, including: an object model generating unit configured to generate an object model using a patch histogram defining a histogram for a partial image obtained by segmenting an object image in an input image into N partial regions; an object probability estimating unit configured to estimate the probability of each image pixel being an object pixel; and a location determining unit configured to determine the most promising location of an object in the image by using the estimated object probability values.

The object model generated by the object model generating unit may include location information of the patch histograms, that is, the location of the corresponding patch region in the object image.

In the object model generating unit, the manner of an object region being divided into partial patch regions or the number of patches may be determined based on what the tracked object is.

The object model generating unit may generate N patch histograms for the N partial image patches.

The object probability estimating unit may estimate an object probability value by using the generated object model.

The object probability estimating unit may obtain a pixel probability defining a probability that a pixel configuring the input image is a pixel configuring the tracked object.

The object probability estimating unit may generate a histogram backprojection image representing the estimated object probability value by an image, and the object probability value used in the location determining unit may be the backprojection image.

The location determining unit may determine a location at which a sum of the pixel probabilities of the pixels included in an object candidate region in the image is maximized as the location of the object by using the generated backprojection image.

Yet another exemplary embodiment of the present invention provides a method for tracking an object in an image, including: generating, by an object model generating unit, an object model using a patch histogram defining histograms for N partial image patches obtained by segmenting an object image in an input image by a predetermined segmentation type according to a tracked object; estimating, by an object probability estimating unit, a pixel probability defining a probability that a pixel configuring an input image is a pixel configuring the tracked object by using the generated object model; and determining, by a location determining unit, a location at which a sum of the pixel probabilities of the pixels included in an object candidate region in the image is maximized by using the estimated pixel probability.

Still another exemplary embodiment of the present invention provides an apparatus for tracking an object in an image, including: an object model generating unit configured to generate an object model using a patch histogram defining histograms for N partial image patches obtained by segmenting an object image in an input image by a predetermined segmentation type according to a tracked object; an object probability estimating unit configured to estimate a pixel probability defining a probability that a pixel configuring an input image is a pixel configuring the tracked object by using the generated object model; and a location determining unit configured to determine a location at which a sum of the pixel probabilities of the pixels included in an object candidate region is maximized in the image by using the estimated pixel probability.

Still yet another exemplary embodiment of the present invention provides a computer-readable recording medium so as to execute a method for tracking an object in an image on a computer including: generating an object model using a patch histogram defining a histogram for a partial image obtained by segmenting an object image in an input image into N partial regions; estimating the probability of each image pixel being an object pixel; and determining the most promising location of an object in the image by using the estimated object probability values.

The method for objecting an object according to the present invention can use the plurality of patch histogram models by region segmentation to preserve the location information and increase the separability of the object region and the background region in the backprojection image. Since the separability from the background for each patch region is increased in the patch histogram models, when the backprojection image is generated by combining the corresponding patch regions, it is possible to more improve the separability from the background than the case of using the single histogram model to improve the tracking performance and to more accurately find out the object region than the mean-shift method of the related art.

The present invention can make the algorithms simple and perform the ultrahigh speed processing (50 Hz or more) and thus can be easily applied to the low-specification platform such as the embedded system and exhibits the more improved tracking performance than other tracking methods.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flow chart showing a method for tracking an object in an image according to an exemplary embodiment of the present invention.

FIGS. 2A and 2B are exemplified diagrams of an object model generated in the generating of an object model according to an exemplary embodiment of the present invention.

FIGS. 3A, 3B, 3C, 3D are exemplified diagram showing a type or number of segmenting an image in the generating of an object model according to an exemplary embodiment of the present invention.

FIG. 4 is an exemplified diagram showing a backprojection image generated in the estimating of an object probability according to an exemplary embodiment of the present invention.

FIG. 5 is an exemplified diagram showing a backprojection image generated according to an exemplary embodiment of the present invention and a backprojection image generated from a single histogram model of the related art.

FIG. 6 is a diagram showing an example of using the backprojection image in the determining of a location according to an exemplary embodiment of the present invention.

FIG. 7A to 7C are exemplified diagrams showing a location of an object determined by the method for tracking an object according to an exemplary embodiment of the present invention.

FIG. 8 is a block diagram showing a configuration of an apparatus for tracking an object.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Only a principle of the present invention will be described below. Therefore, although the principle of the present invention is not clearly described or shown in the specification, those skilled in the art can implement a principle of the present invention and invent various apparatuses included in a concept and a scope of the present invention. Conditional terms and embodiments described in the specification are in principle used only for purposes for understanding the concept of the present invention and are to be construed as being not limited to specifically described embodiments and states.

Hereinafter, exemplary embodiments of the present invention will be described in detail with reference to the accompanying drawings. Hereinafter, substantially the same components are each denoted by the same reference numerals in the following description and the accompanying drawings, and therefore a repeated description thereof will be omitted. In describing the present invention, when it is determined that the detailed description of the known art or configurations related to the present invention may obscure the gist of the present invention, the detailed description thereof will be omitted.

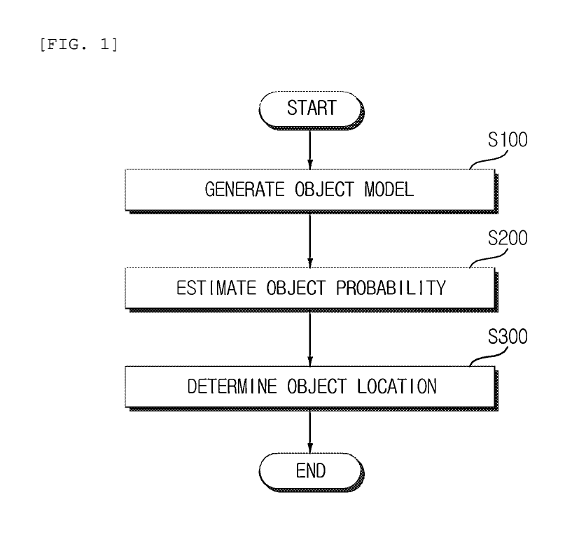

FIG. 1 is a flow chart showing a method for tracking an object in an image according to an exemplary embodiment of the present invention. Referring to FIG. 1, the method for tracking an object according to the exemplary embodiment of the present invention includes generating an object model (S100), estimating an object probability (S200), and determining an object location (S300).

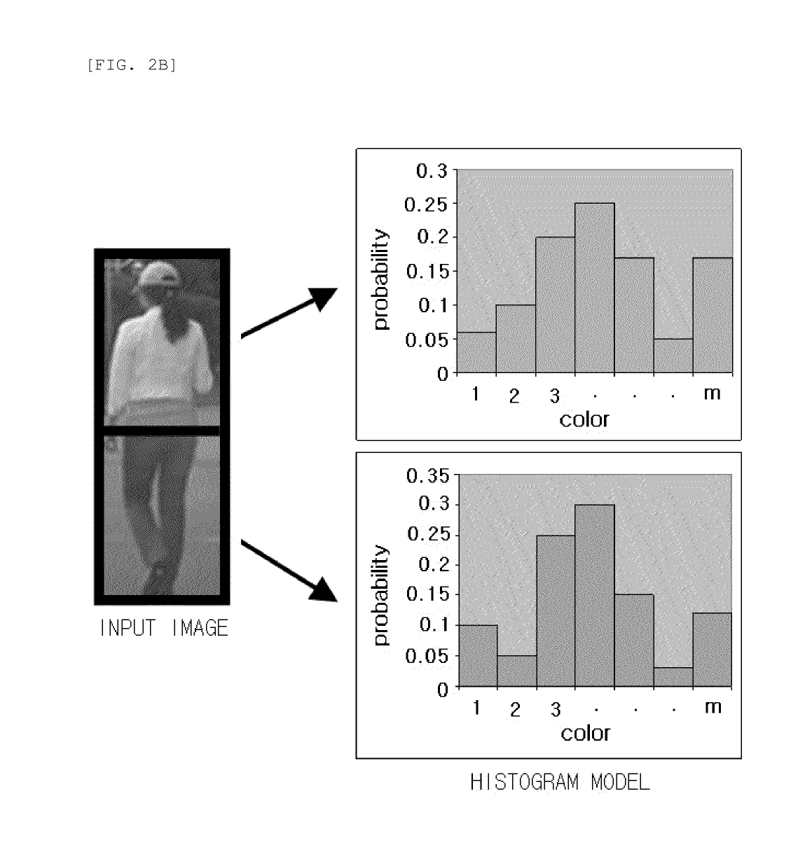

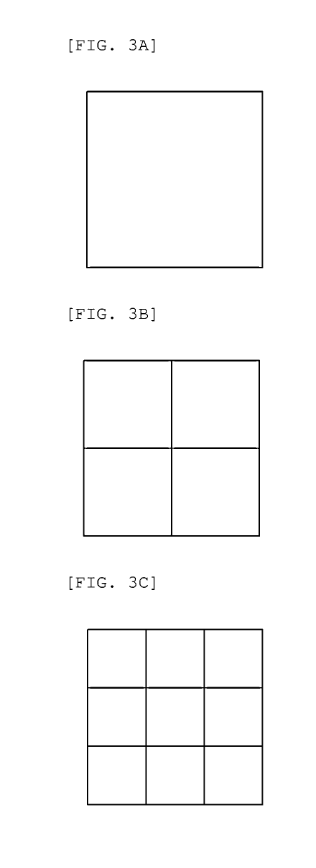

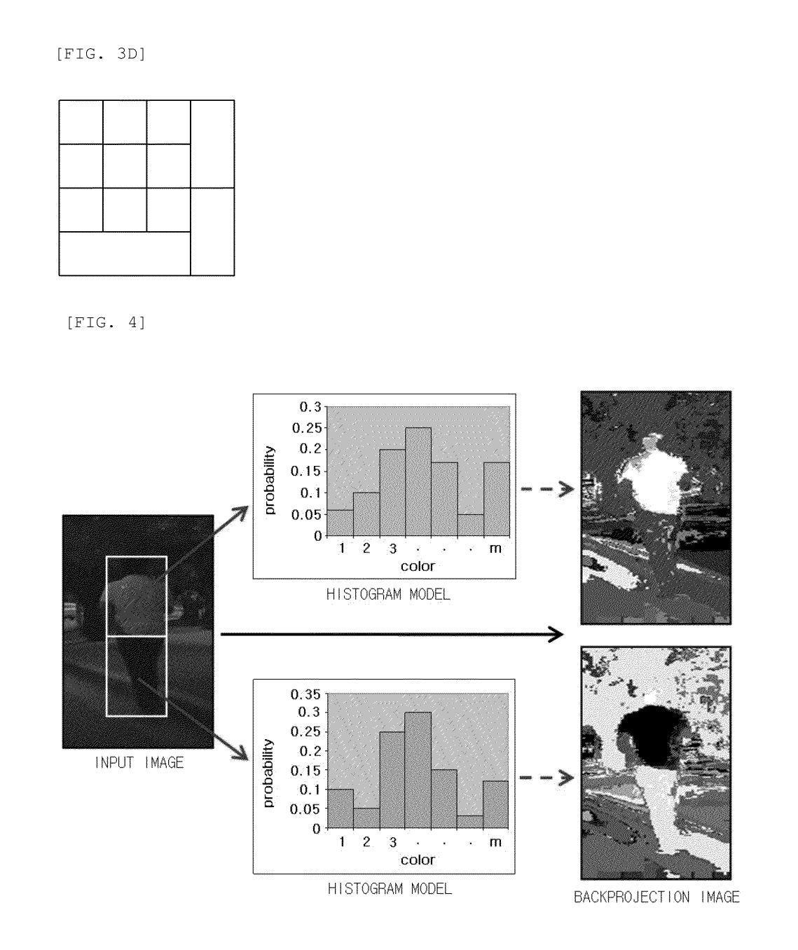

In the generating of the object model (S100), an object model is generated by an object model generating unit, an object model represented by multiple patch histograms of an object (an object region in an input image is divided into N partial patch regions and histograms are built from each patch region, forming an object model) In the exemplary embodiment of the present invention, the object region in the input image is segmented according to a segmentation type or a segmentation number determined based on what the tracked object is. Herein, it is preferable to segment the image into a predetermined section as shown in FIGS. 3A, 3B, 3C and 3D based on the segmentation type or the segmentation number. Determining the segmentation type or the segmentation number based on what the object is means determining the segmentation type or the segmentation number in consideration of general characteristics of the object in order to increase accuracy of results of tracking a location of an object to be achieved by the exemplary embodiment of the present invention. For example, when the object to be tracked is a person, an upper body and a lower body generally have a similar color distribution, and thus the object to be tracked may be segmented into a block form of two rows×one column. When the segmentation number is 1, the exemplary embodiment of the present invention includes the same model as a histogram model of tracking an object using a single histogram model of the related art. Therefore, in the exemplary embodiment of the present invention, the patch histogram may mean the histogram model for the segmented region that is segmented into patches, that is, pieces.

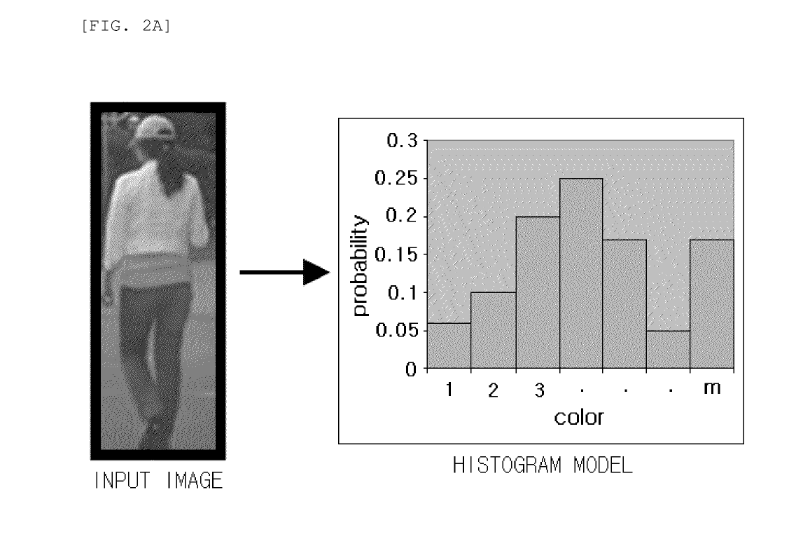

The object model generated in the generating of the object model (S100) includes the location information of the patch histograms, that is, the location of the corresponding patch region in the object image. The generating of the object model (S100) may generate N patch histograms for N segmented partial image patches. Referring to FIG. 2A, the histogram model generated in the method for tracking an object of the related art uses the single histogram and thus indicates color configuration information regarding all the regions but cannot include the location information of colors. However, referring to FIG. 2B, the histogram model according to the exemplary embodiment of the present invention generates each histogram for the segmented regions and thus may maintain the location information on which portions in the input image corresponds to the segmented regions. Therefore, the histograms generated for the segmented regions may include the location information. For example, in case in which the image is segmented in a size of a pixel as a unit at the time of segmenting the image, the histogram model including the location information regarding all the pixels may be generated.

Therefore, the object model generated in the generating of the object model (S100) according to the exemplary embodiment of the present invention may include the histogram models for each segmented region and a model including the location information of the segmented regions. An initial location of an object for generating the object model may be provided from a separate detection system or directly set by a user. After the object model is generated from the image region for the initial location, for the subsequently input images, a targeted object is tracked using the generated object model.

In the estimating of the object probability (S200), an object probability value of the image is estimated using the object model generated in the generating of the object model (S100) as described above. In the estimating of the object probability (S200), the pixel probability it is desirable to estimate the probability of an image pixel being populated from an target object. In the exemplary embodiment of the present invention, in order to obtain the pixel probability of the input image, a histogram backprojection method is applied to the input image. In the generating of the object model (S100), when the number of segmented regions for the targeted object is set to be N and the generated patch histogram models are set to be H1, H2, . . . , HN, each pixel probability is calculated for each patch histogram to generate N backprojection images (representing the pixel probability as the image). When the generated backprojection images are each set to be p1, p2, . . . , pN, pi is represented by Equation 1 or 2.

$$\begin{matrix}{p}_{i} ( x ) = \sqrt{\frac{{H}_{i} ( I ( x ) )}{{H}_{c} ( I ( x ) )}} & [ Equation 1 ] \\ {P}_{i} ( x ) = {H}_{i} ( I ( x ) ) & [ Equation 2 ]\end{matrix}$$

In the above Equations, x represents each pixel included in the image, I represents the input image, and Hc represents a histogram for a search region within the input image. Therefore, in the exemplary embodiment of the present invention, Equations 1 or 2 may be used for the histogram backprojection. Estimating the probability using Equation 1 can remove the effect of background and thus is more effective for the tracking of an object. Other similar modifications can also be sufficiently applied. In Equation 1, Hc represents the histogram for the search region within the input image, wherein the search region means the image region in which the search for the actually targeted object among the input images is performed. Generally, since the location change of the specific object is not large in consecutive image frames, it may be effective to perform the search only on the region within a predetermined radius from a location of an object in a previous frame rather than searching an object in the entire image.

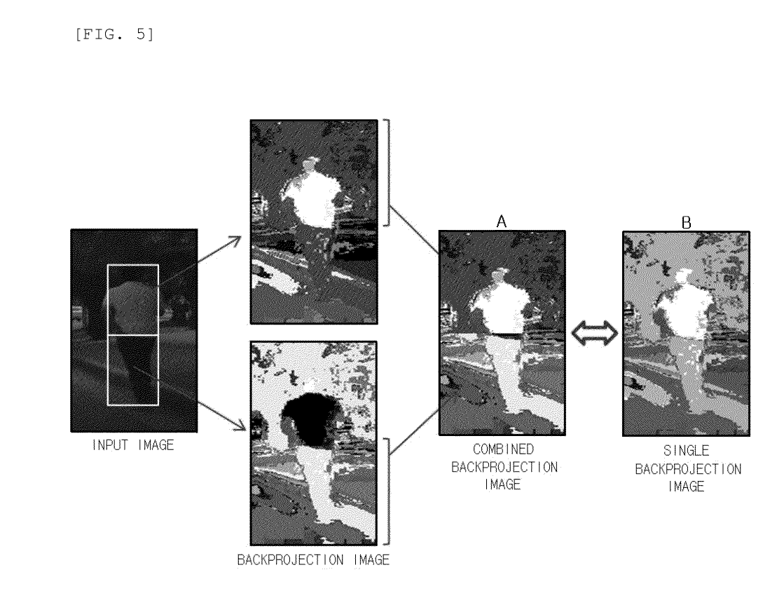

Referring to FIG. 4, the backprojection image generated in the estimating of the object probability (S200) according to the exemplary embodiment of the present invention can be observed. The object (person) is segmented into two regions, that is, the upper body and the lower body in the input image and the histogram models for each of the segmented images are generated. When the histogram backprojection is applied to the input image using the generated patch histogram model, the pixels belonging to the segmented region have the high pixel probability and thus brightly appear on the backprojection image.

Referring to FIG. 5, the backprojection image generated by using the single histogram model according to the related art and the backprojection image generated using the patch histogram model according to the exemplary embodiment of the present invention can be compared. Referring to the results that the back projection images generated by using the patch histogram model are combined using the location information regarding the patch histogram model, a boundary between the object and the background is more clear than the results using the single histogram model, and therefore it can be appreciated that the separability between the object and the background becomes good.

Therefore, in the generating of the object model (S100), the number of segmented regions is N and the backprojection image representing each of the object probability values generated therefore by the image is generated. Therefore, the object probability value used in the determining of the location (S300) of the method for tracking an object according to the exemplary embodiment of the present invention may be the backprojection image. The determining of the location (S300) will be described below in detail.

In the determining of the location (S300), the location of the object in the image is determined using the object probability value estimated in the estimating of the object probability (S200). The object probability value used in the determining of the location (S300) of the method for tracking an object according to the exemplary embodiment of the present invention may be the backprojection image represented by an image the object probability value estimated in the estimating of the object probability (S200) as described above by the image and the location of the object determined using the same may be a location in which a sum of the pixel probabilities of the pixels included in an object candidate region is maximal in the image.

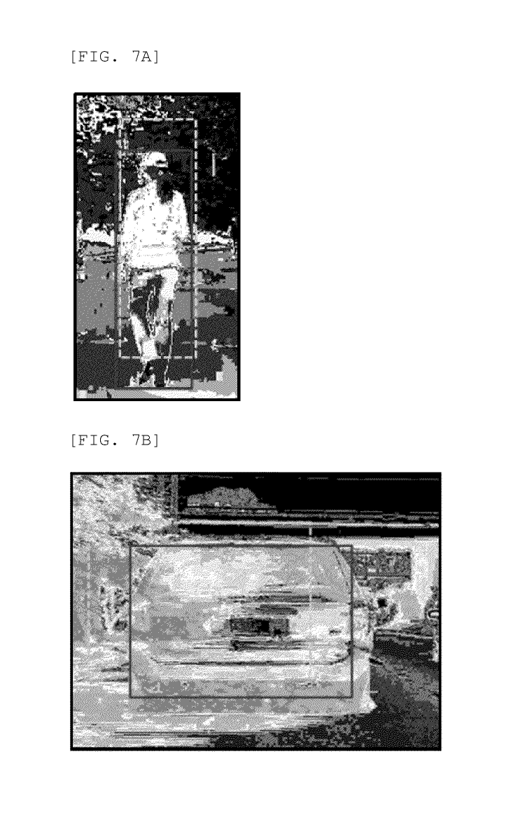

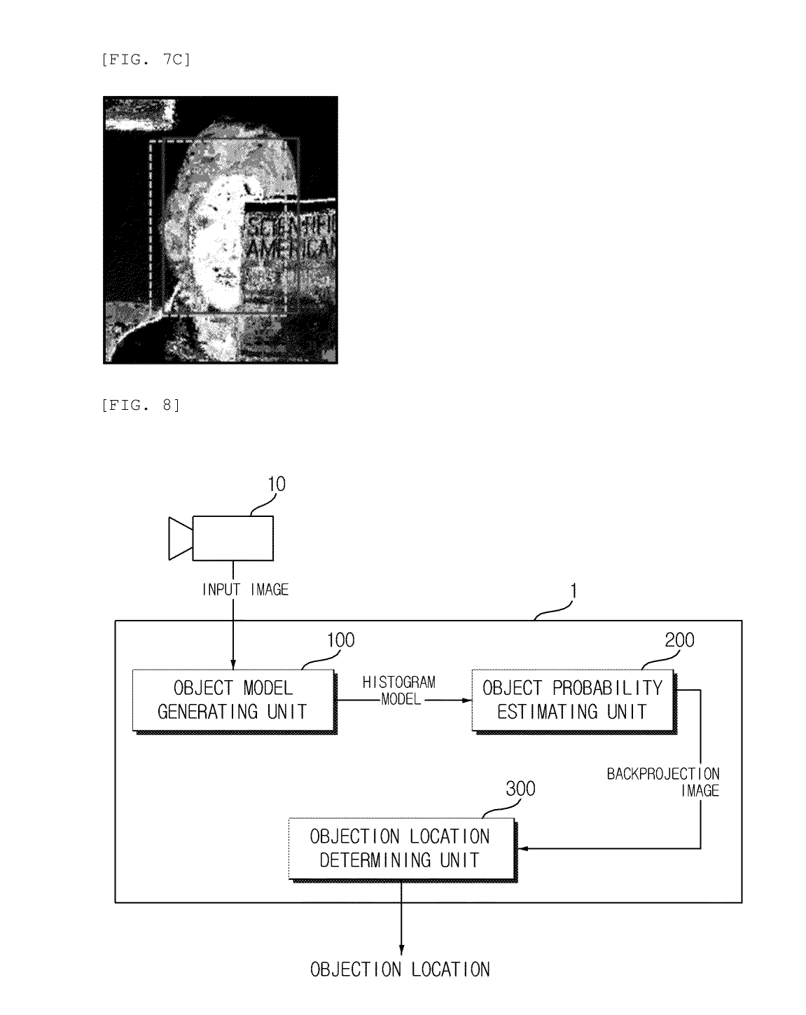

In the mean-shift method of the related art, points at which the pixel probability values form peak values are searched by repeating a process of obtaining local density mean coordinates (local density mean coordinates) of a window from the pixel probability values within the local window, moving the local window to the corresponding local density mean, and again obtaining and moving the local density mean within the moved local window. On the other hand, the method for determining a location of an object in the determining of the location (S300) according to the exemplary embodiment of the present invention determines the location of the targeted object so that a sum of the pixel probability values incoming into the local window is maximal. Referring to FIGS. 7A to 7C, the location of the object tracked by the mean-shift method for the same object may compare with the location determined in the determining of the location (S300) according to the exemplary embodiment of the present invention. A quadrangle represents the local window determined as the location of the object, a dotted line represents results of using the mean-shift method of the related art, and a solid line represents results according to the exemplary embodiment of the present invention. Each case represents the case in which the probability distribution in the object is not uniform in FIG. 7A, the case in which the surrounding background has the color distribution similar to the object in FIG. 7B, and the case in which the object is partially covered and it can be appreciated that it is difficult for the mean-shift method of the related art to more accurately search the location of the object than the method for tracking an object according to the exemplary embodiment of the present invention in FIG. 7C. Hereinafter, the method for determining a location of an object determined according to the exemplary embodiment of the present invention will be described in detail.

The location x̅* of the object determined according to the exemplary embodiment of the present invention is determined by the following Equation 3.

$${\overline{x}}^{*} = {argmax}_{\overline{x}} {\sum }_{k} p ( {x}_{k} ) \qquad [ Equation 3 ]$$

In the above Equation 3, xₖ represents the coordinates of the pixels within the current local window, x̅ represents the central coordinates of the local window, and p(xₖ) represents the pixel probability in the backprojection image for xₖ.

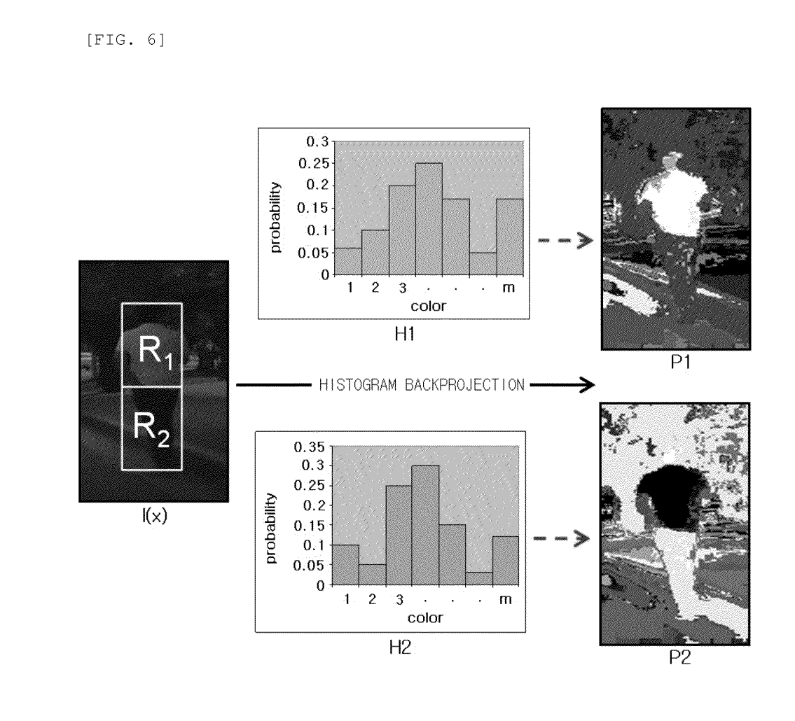

In the exemplary embodiment of the present invention, the backprojection image used in the determining of the location (S300) may be the backprojection image generated from the patch histogram corresponding to the pixel included in the candidate region. When the single histogram model is used, p(xₖ) is uniquely determined. However, when the plurality of patch histogram models are used, a total n of backprojection images are present, and thus the p(xₖ) value uses the pixel probability in the backprojection image generated from the patch histogram corresponding to the location xₖ within the current local window. For example, referring to FIG. 6, as shown in FIG. 6, when 2×1 segmentation is used, a probability value p(xₖ)=p₁(xₖ) is used for a pixel location belonging to R1 and a probability value of p(xₖ)=p₂(xₖ) is used for the pixel location belonging to R2.

As described above, the method for tracking an object according to the present invention can use the plurality of patch histogram models by region segmentation to preserve the location information and increase the separability of the object region and the background region in the backprojection image. Since the separability from the background for each patch region is increased in the patch histogram models, when the backprojection image is generated by combining the corresponding patch regions, it is possible to more improve the separability from the background than the case of using the single histogram model to improve the tracking performance and more accurately find out the object region than the mean-shift method of the related art.

Meanwhile, a method for tracking an object in an image according to another exemplary embodiment of the present invention includes the generating of the object model (S100), the estimating of the object probability (S200), and the determining of the location (S300).

According to the exemplary embodiment of the present invention, in the generating of the object model (S100), the object model may be generated using the patch histogram defining the histogram for N partial image patches obtained by segmenting the object region in the input image by the predetermined segmentation type according to the tracked object, in the estimating of the object probability (S200), the pixel probability defining the probability that the pixel configuring the input image is the pixel configuring the tracked object may be estimated using the generated object model, and in the determining of the location (S300), the location at which the sum of the pixel probabilities of the pixels included in the object candidate region in the image is maximized may be determined using the estimated pixel probability. The foregoing each step includes each step of the method for tracking an object according to the foregoing exemplary embodiment of the present invention and the description thereof is omitted.

Hereinafter, an apparatus performing the method for tracking an object in the image according to the exemplary embodiment of the present invention will be described. Referring to FIG. 8, an apparatus 1 for tracking an object according to an exemplary embodiment of the present invention includes an object model generating unit 100, an object probability estimating unit 200, and an object location determining unit 300.

The object model generating unit 100 performs the generating of the object model (S100) as described above and generates the object model using the patch histogram defining the histogram for the partial image obtained by segmenting the object region into N partial region in the image input from an image apparatus 10.

As described above, in the exemplary embodiment of the present invention, the object model includes the location information of the patch histograms, that is, the location of the corresponding patch region in the object image and the segmentation type or number of the image may be determined according to what the tracked object is. The object model generating unit 100 generates N patch histograms for N partial image patches.

The object probability estimating unit 200 performs the estimating of the object probability (S200) and estimates the object probability value of the input image by using the generated object model. As described above, the object probability value may be estimated according to the N generated patch histogram models. In more detail, the pixel probability defining the probability that the pixel configuring the input image is the pixel configuring the tracked object may be obtained. The object probability estimating unit generates the histogram backprojection image representing the estimated object probability value by the image, which is used as the object probability value in the location determining unit to be described below.

The location determining unit 300 performs the determining of the location (S300) and determines the location of the object in the image by using the estimated object probability value as described above. The location determining unit 300 determines the location at which the sum of the pixel probability of the pixels included in the object candidate region in the image is maximal as the location of the object by using the generated histogram backprojection image, wherein the histogram backprojection image used in the location determining unit 300 may be the histogram backprojection image generated from the patch histogram corresponding to the pixel included in the candidate region.

Meanwhile, the method for tracking an object in an image according to the exemplary embodiment of the present invention in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for tracking an object in an image, comprising:
generating, by an object model generating unit, an object model represented by multiple patch histograms of an object that is divided into N partial patch regions and histograms are built from each patch region, forming an object model;
estimating, by an object probability estimating unit, the probability of each image pixel being an object pixel; and
determining, by a location determining unit, the most promising location of an object in the image by using the estimated object probability values.

2. The method of claim 1, wherein: the object model generated in the generating of the object model includes location information of the patch histograms, that is, the location of the corresponding patch region in the object image.

3. The method of claim 1, wherein: in the generating of the object model, the manner of an object region being divided into partial patch regions or the number of patches is determined based on what the tracked object is.

4. The method of claim 1, wherein: in the generating of the object model, N patch histogram models for the N partial image patches are generated.

5. The method of claim 4, wherein: in the estimating of the object probability, an object probability value is estimated by using the generated object model.

6. The method of claim 5, wherein: in the estimating of the object probability, it is desirable to estimate the probability of an image pixel being populated from an target object.

7. The method of claim 6, wherein: in the estimating of the object probability, forming a histogram backprojection image where the value of each pixel denotes the object probability, and
the object probability value used in the location determining unit is the backprojection image.

8. The method of claim 7, wherein: in the determining of the location, a location at which the sum of the pixel probabilities of an object candidate region in the generated backprojection image is maximized may be determined as the location of the object.

9. The method of claim 8, wherein: the backprojection image used in the determining of the location is a backprojection image generated from the patch histogram corresponding to the pixel included in the candidate region.

10. An apparatus for tracking an object in an image, comprising:
an object model generating unit configured to generate an object model represented by multiple patch histograms of an object that is divided into N partial patch regions and histograms are built from each patch region, forming an object model;
an object probability estimating unit configured to estimate the probability of each image pixel being an object pixel; and
a location determining unit configured to determine the most promising location of an object in the image by using the estimated object probability values.

11. The apparatus of claim 10, wherein: the object model generated by the object model generating unit includes location information of the patch histograms, that is, the location of the corresponding patch region in the object image.

12. The apparatus of claim 10, wherein: in the object model generating unit, the manner of an object region being divided into partial patch regions or the number of patches is determined based on what the tracked object is.

13. The apparatus of claim 10, wherein: the object model generating unit generates N patch histogram models for the N partial image patches.

14. The apparatus of claim 13, wherein: the object probability estimating unit estimates an object probability value by using the generated object model.

15. The apparatus of claim 14, wherein: the object probability estimating unit, it is desirable to estimate the probability of an image pixel being populated from an target object.

16. The apparatus of claim 15, wherein: the object probability estimating unit generates forming a histogram backprojection image where the value of each pixel denotes the object probability, and
the object probability value used in the location determining unit is the backprojection image.

17. The apparatus of claim 16, wherein: the location determining unit determines a location at which the sum of the pixel probabilities of an object candidate region in the generated backprojection image is maximized may be determined as the location of the object.

18. A method for tracking an object in an image, comprising:
generating, by an object model generating unit, an object model using a patch histogram defining histograms for N partial image patches obtained by segmenting an input object image by a predetermined segmentation type according to a tracked object;
estimating, by an object probability estimating unit, a pixel probability defining a probability that a pixel configuring an input image is a pixel configuring the tracked object by using the generated object model; and
determining, by a location determining unit, a location at which a sum of the pixel probabilities of the pixels included in an object candidate region in the image is maximized by the estimated pixel probability.

19. An apparatus for tracking an object in an image, comprising:
an object model generating unit configured to generate an object model using a patch histogram defining histograms for N partial image patches obtained by segmenting an input object image by a predetermined segmentation type according to a tracked object;
an object probability estimating unit configured to estimate a pixel probability defining a probability that a pixel configuring an input image is a pixel configuring the tracked object by using the generated object model; and
a location determining unit configured to determine a location at which a sum of the pixel probabilities of the pixels included in an object candidate region is maximized in the image by using the estimated pixel probability.
